(19) United States
(12) Patent Application Publication
(10) Pub. No.: US 2008/0212209 A1
(43) Pub. Date: Sep. 4, 2008

(54) OPTICAL LENS DEVICE SOLDERABLE TO SUBSTRATE AND METHOD OF MANUFACTURING THE OPTICAL LENS DEVICE

(75) Inventor: Shigeru HATAKEYAMA, Fukushima-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/019,123

(22) Filed: Jan. 24, 2008

(30) Foreign Application Priority Data
Feb. 19, 2007 (JP) 2007-037834

(51) Int. Cl. G02B 7/02; B23P 15/00

(52) U.S. Cl. 359/811; 29/469

(57) ABSTRACT

A method of manufacturing an optical lens device includes the steps of forming a lens barrel into the shape of a quadrangular prism having corners that have a shape having a radius of curvature or that are chamfered, and installing a lens into the lens barrel; disposing in parallel a plurality of the lens barrels in which a plurality of the lenses are installed; masking the lens at one side face of each lens barrel disposed in parallel, and the vicinity of the lens; and depositing a gold layer by sputtering on the one side face of each masked lens barrel, including the corners.

### CLAIM OF PRIORITY

This application claims benefit of the Japanese Patent Application No. 2007-037834 filed on Feb. 19, 2007, which is hereby incorporated by reference.

### BACKGROUND OF THE INVENTION

1. Field of the Invention

The present invention relates to an optical lens device that has an edge portion or a lens barrel at a periphery of a lens and that is solderable to a substrate, and to a method of manufacturing the optical lens device. More particularly, the present invention relates to an optical lens device in which a gold layer is formed only on one side face of an edge portion or of a lens barrel, and to a method of manufacturing the optical lens device.

2. Description of the Related Art

In an optical lens device having a glass lens accommodated in a metallic lens barrel, a gold layer may be required in the lens barrel or an edge portion, to solder the optical lens device to a substrate. Hitherto, the gold layer is formed by electrolytic gold plating after plating the lens barrel with electrolytic nickel. An example of forming a layer onto a surface of the lens barrel by plating is discussed in, for example, Japanese Unexamined Patent Application Publication No. 2002-107597.

However, since electrolytic plating is a batch processing, when considering production efficiency, a few hundred to approximately a thousand optical lens devices need to be processed all together. Therefore, when a problem arises, all products may be defective. In addition, since the lens is formed under high temperature after plating, it is necessary to consider the effects of diffusion during the formation, and form the nickel layer and the gold layer to thicknesses on the order of a few um. This increases costs. Further, when the electrolytic plating is performed, the nickel layer and the gold layer are formed on the entire peripheral face of the edge portion or the lens barrel. Here, only one face is needed for soldering. When plating is performed on other faces, costs are further increased.

### SUMMARY OF THE INVENTION

In view of the above-described problems, the present invention provides an optical lens device that can reduce the amount of gold used while ensuring strength of joining the optical lens device with a substrate by soldering, and a method of manufacturing the optical lens device.

To this end, according to a first aspect of the present invention, there is provided a method of manufacturing an optical lens device in which a lens is held in a metallic lens barrel. The method comprises the steps of forming the lens barrel into the shape of a quadrangular prism having corners that have a shape having a radius of curvature or that are chamfered, and installing the lens into the lens barrel; disposing in parallel a plurality of the lens barrels in which a plurality of the lenses are installed; masking the lens at one side face of each lens barrel disposed in parallel, and the vicinity of the lens; and depositing a gold layer by sputtering on the one side face of each masked lens barrel, including the corners.

According to a second aspect of the present invention, there is provided a method of manufacturing an optical lens device in which an edge portion is formed at a periphery of a glass lens. The method comprises the steps of forming the edge portion into the shape of a quadrangular prism having corners that have a shape having a radius of curvature or that are chamfered, and disposing in parallel a plurality of the optical lens devices having a plurality of the edge portions; masking the lens at one side face of the edge portion of each optical lens device disposed in parallel, and the vicinity of the lens; and depositing a gold layer by sputtering on the one side face of the edge portion of each masked optical lens device, including the corners.

In one form of the method of manufacturing an optical lens device, a titanium layer and a platinum layer are formed on the one side face of each masked lens barrel or one side face of a masked edge portion, and the gold layer is deposited thereon.

According to a third aspect of the present invention, there is provided an optical lens device in which a lens is held in a metallic lens barrel. The lens barrel is formed into the shape of a quadrangular prism having corners that have a shape having a radius of curvature or that are chamfered, and a gold layer is disposed on only one side face of the lens barrel, including the corners.

According to a fourth aspect of the present invention, there is provided an optical lens device in which an edge portion is formed at a periphery of a glass lens. The edge portion is formed into the shape of a quadrangular prism having corners that have a shape having a radius of curvature or that are chamfered, and a gold layer is disposed on only one side face of the edge portion, including the corners.

In one form of the optical lens device, a titanium layer and a platinum layer are disposed on the one side face of the lens barrel or one side face of an edge portion so as to be disposed below the gold layer.

The method of manufacturing an optical lens device according to the first aspect of the present invention includes the steps of forming the lens barrel into the shape of a quadrangular prism having corners that have a shape having a radius of curvature or that are chamfered, and installing the lens into the lens barrel; disposing in parallel a plurality of the lens barrels in which a plurality of the lenses are installed; masking the lens at one side face of each lens barrel disposed in parallel, and the vicinity of the lens; and depositing a gold layer by sputtering on the one side face of each masked lens barrel, including the corners. Therefore, since each gold layer can be formed on only one side face required for soldering and the corners at both sides thereof, the amount of gold used can be reduced. In addition, since each gold layer can be formed after forming the lens, each gold layer need not be made thick in consideration of each gold layer being subjected to high temperature. Accordingly, even due to this, the amount of gold used can be reduced, so that costs can be reduced. Still further, for an optical lens device in which a lens and an edge portion are integrally formed using glass, similar effects can be obtained.

In addition, according to the method of manufacturing an optical lens device according to the first form of the present invention, a titanium layer and a platinum layer are formed on the one side face of each masked lens barrel or one side face of a masked edge portion, and the gold layer is deposited thereon. Therefore, good adhesion of each gold layer can be achieved, so that sufficient soldering strength can be ensured.

Still further, according to the optical lens device according to the third aspect of the present invention, the lens barrel is formed into the shape of a quadrangular prism having corners that have a shape having a radius of curvature or that are chamfered, and a gold layer is disposed on only one side face of the lens barrel, including the corners. Accordingly, since the gold layer is formed on only one side face of the lens barrel and the corners, it is possible to reduce costs by reducing the amount of gold used. In addition, for an optical lens device in which a lens and an edge portion are integrally formed using glass, similar effects can be obtained.

Still further, according to the optical lens device according to the first form of the present invention, a titanium layer and a platinum layer are disposed on the one side face of the lens barrel or one side face of an edge portion so as to be disposed below the gold layer. Therefore, good adhesion of the gold layer can be achieved, so that sufficient soldering strength can be ensured.

### BRIEF DESCRIPTION OF THE DRAWINGS

FIG. 1 is a front view of an optical lens device according to an embodiment of the present invention;

FIG. 2 is a sectional view taken along line II-II shown in FIG. 1;

FIG. 3 is a front view of the optical lens device mounted to a substrate; and

FIGS. 4A to 4F show the steps of manufacturing the optical lens device.

### DESCRIPTION OF THE PREFERRED EMBODIMENTS

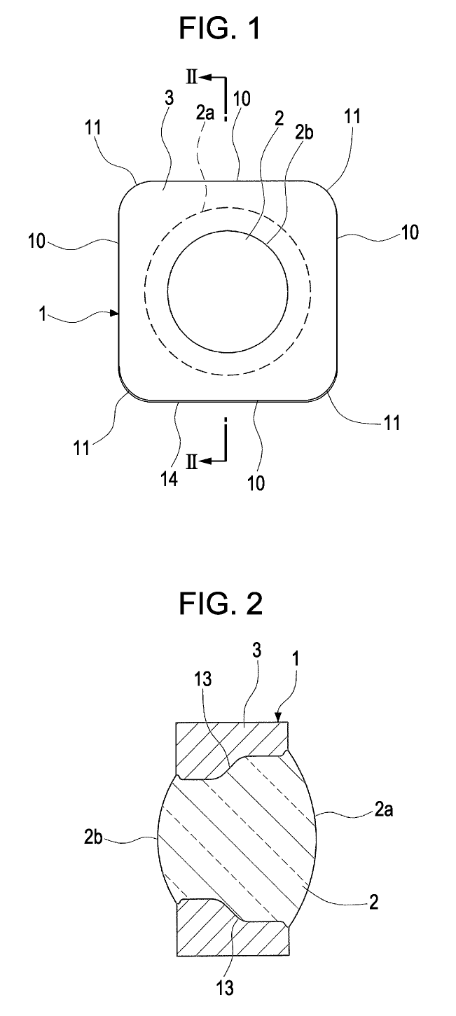

An embodiment of the present invention will now be described in detail with reference to the drawings. FIG. 1 is a front view of an optical lens device according to the embodiment of the present invention. FIG. 2 is a sectional view taken along line II-II shown in FIG. 1. As shown in FIG. 1, in an optical lens device 1 according to the embodiment, a glass lens 2 is accommodated in a metallic lens barrel 3.

As shown in FIGS. 1 and 2, the lens barrel 3 has an external shape of a quadrangular prism. The lens barrel 3 has four side faces 10. Portions between the side faces 10 have shapes having a radius of curvature (hereafter referred to as “R shapes”), so that four corners 11 are formed. The corners 11 are not limited to those having R shapes. The corners 11 may be chamfered by being linearly cut. In addition, as shown in FIG. 2, the internal portion of the lens barrel 3 is formed into a cylindrical shape that can accommodate the lens 2, and steps 13 are formed at intermediate positions of the lens barrel 3, so that a second opening is smaller than a first opening.

The lens 2 has a first lens portion 2a and a second lens portion 2b. The first lens portion 2a is exposed from the first opening of the lens barrel 3, and the second lens portion 2b is exposed from the second opening of the lens barrel 3. Due to the shape of the lens barrel 3, the diameter of the second lens portion 2b is smaller than the diameter of the first lens portion 2a. Although, in the embodiment, the lens portions 2a and 2b of the lens 2 are formed as convex lens portions, the present invention is not limited thereto, so that the lens portions 2a and 2b may be formed as concave lens portions.

A gold layer 14 is formed on one side face 10 of the lens barrel 3. In addition, gold layers 14 are formed continuously on corners 11 at both sides of the one side face 10. The gold layers 14 are thin gold films deposited on the side face 10 and the corners 11. The lens barrel 3 is formed of stainless steel, has a titanium layer that contacts the stainless steel, has a platinum layer formed on the titanium layer, and has the gold layers 14 formed on the platinum layer.

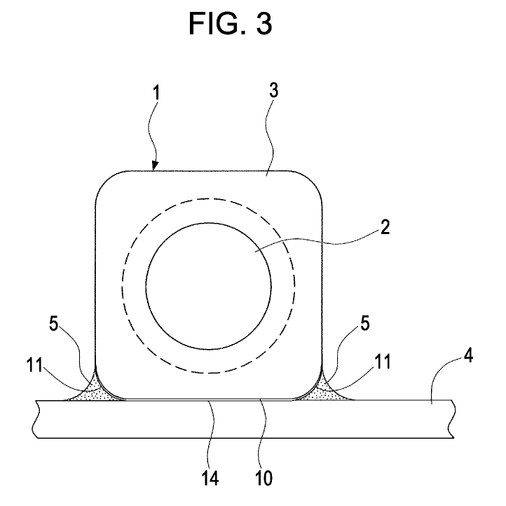

FIG. 3 is a front view of the optical lens device 1 mounted to a substrate 4. The optical lens device 1 is secured to the substrate 4 by soldering. As shown in FIG. 3, solder 5 is provided so as to be applied from the one side face 10 of the lens barrel 3 to the corners 11 at both sides thereof, to secure the lens barrel 3 to the substrate 4. Since the gold layers 14 are formed on the lens barrel 3 so as to be provided in the area where the solder 5 is provided, that is, on the one side face 10 contacting the substrate 4 and on the corners 11 at both sides of the one side face 10, sufficient soldering strength can be ensured.

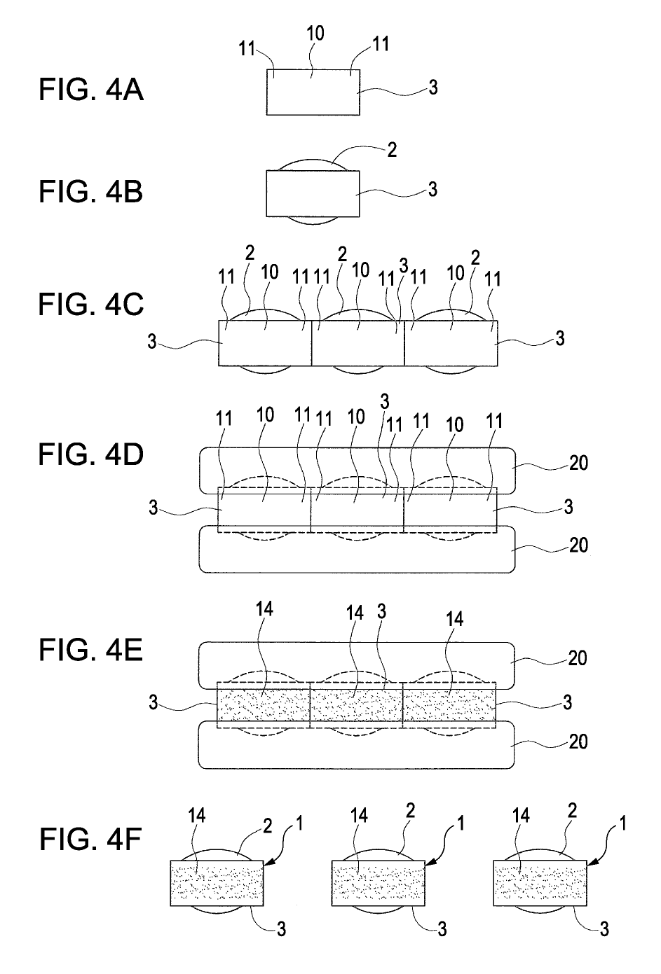

Next, a method of manufacturing the optical lens device 1 according to the embodiment will be described. FIGS. 4A to 4F illustrate the steps of manufacturing the optical lens device 1. As shown in FIG. 4A, first, a lens barrel 3 is formed into the shape of a quadrangular prism having corners 11. Then, as shown in FIG. 4B, a lens 2 is formed in the lens barrel 3. The lens 2 is placed so that spherical glasses overlap steps 13 in the lens barrel 3, and is interposed with a mold from both openings of the lens barrel 3. Then, it is heated, to soften the spherical glasses, so that the spherical glasses are formed into the shape of the mold.

Next, as shown in FIG. 4C, a plurality of lens barrels 3, each having a molded lens 2, are disposed in parallel. Here, side faces 10, where gold layers 14 are formed, of the lens barrels 3 are disposed in parallel so as to face one direction. When the lens barrels 3 are disposed in parallel in this way, as shown in FIG. 4D, a mask jig 20 is disposed so as to cover the lenses 2 and the vicinity thereof.

In this state, metallic layers are deposited by sputtering on one side face 10 of each lens barrel 3 exposed to one side and on corners 11 at both sides thereof. First, a titanium layer is formed on a surface of stainless steel making up each lens barrel 3. Then, a platinum layer is formed thereon. Finally, each gold layer is formed thereon, thereby ending the sputtering. By this, as shown in FIG. 4E, the gold layer 14 is formed on only the one side face 10 of each lens barrel 3 and the corners 11 at both sides thereof.

Accordingly, by forming the gold layers 14 by sputtering, the gold layers 14 can be formed only on portions shown in FIG. 3 required for soldering. Therefore, it is possible to reduce costs by reducing the amount of gold used. In addition, since the gold layers 14 can be formed after molding the lenses 2, the gold layers 14 that have been formed are not exposed to high temperature for molding the lenses. Therefore, it is possible to form the gold layers 14, the titanium layers, and the platinum layers into thin layers. Consequently, it is also possible to reduce costs by reducing the amount of gold used.

Lastly, as shown in FIG. 4F, the mask jig 20 is removed to separate the lens barrels 3 disposed in parallel from each other, so that optical lens devices 1 are completed.

Although an embodiment of the present invention is described, the application of the present invention is not limited thereto, so that the present invention can be variously applied within the scope of the technical idea of the present invention. For example, although, in the embodiment, the lens 2 is held in the lens barrel 3, the present invention may be similarly applied to an optical lens device 1 in which an edge portion is integrally formed with a peripheral portion of a lens 2. In this case, the external shape of the optical lens device 1 is similar to that of the optical lens device 1 in which the lens 2 is accommodated in the lens barrel 3. The edge portion is formed into the shape of a quadrangular prism, and the corners have an R shape or are chamfered. Then, the lens and the edge portion are integrally formed using glass, to form the optical lens device. Then, a plurality of optical lens devices are disposed in parallel, to form a gold layer on one side face of each edge portion and the corners at both sides thereof. Here too, similarly to when a gold layer 14 is formed on each stainless-steel lens barrel 3, a titanium layer is formed on a glass surface, a platinum layer is formed on the titanium layer, and a gold layer is formed on the platinum layer, so that it is possible to form a gold layer having good adhesion.

Although, in the embodiment, sputtering is carried out on the plurality of lens barrels 3 disposed in parallel, sputtering may be carried out on one lens barrel 3. This also applies to an optical lens device integrally formed using glass so as to have an edge portion.

What is claimed is:

1. A method of manufacturing an optical lens device in which a lens is held in a metallic lens barrel, the method comprising the steps of:
forming the lens barrel into the shape of a quadrangular prism having corners that have a shape having a radius of curvature or that are chamfered, and installing the lens into the lens barrel;
disposing in parallel a plurality of the lens barrels in which a plurality of the lenses are installed;
masking the lens at one side face of each lens barrel disposed in parallel, and the vicinity of the lens; and
depositing a gold layer by sputtering on the one side face of each masked lens barrel, including the corners.

2. A method of manufacturing an optical lens device in which an edge portion is formed at a periphery of a glass lens, the method comprising:
forming the edge portion into the shape of a quadrangular prism having corners that have a shape having a radius of curvature or that are chamfered, and disposing in parallel a plurality of the optical lens devices having a plurality of the edge portions;
masking the lens at one side face of the edge portion of each optical lens device disposed in parallel, and the vicinity of the lens; and
depositing a gold layer by sputtering on the one side face of the edge portion of each masked optical lens device, including the corners.

3. The method of manufacturing an optical lens device according to claim 1, wherein a titanium layer and a platinum layer are formed on the one side face of each masked lens barrel or one side face of a masked edge portion, and the gold layer is deposited thereon.

4. An optical lens device in which a lens is held in a metallic lens barrel, wherein the lens barrel is formed into the shape of a quadrangular prism having corners that have a shape having a radius of curvature or that are chamfered, and a gold layer is disposed on only one side face of the lens barrel, including the corners.

5. An optical lens device in which an edge portion is formed at a periphery of a glass lens, wherein the edge portion is formed into the shape of a quadrangular prism having corners that have a shape having a radius of curvature or that are chamfered, and a gold layer is disposed on only one side face of the edge portion, including the corners.

6. The optical lens device according to claim 4, wherein a titanium layer and a platinum layer are disposed on the one side face of the lens barrel or one side face of an edge portion so as to be disposed below the gold layer.
